(19) United States
(12) Patent Application Publication
(10) Pub. No.: US 2018/0121470 A1
(43) Pub. Date: May 3, 2018

(54) Object Annotation in Media Items

(71) Applicant: Ambient Consulting, LLC, Minnetonka, MN (US)

(72) Inventors: Andrew Grossman, Hopkins, MN (US); Tom Marlin, Maple Grove, MN (US)

(73) Assignee: Ambient Consulting, LLC, Minnetonka, MN (US)

(21) Appl. No.: 15/852,060

(22) Filed: Dec. 22, 2017

Related U.S. Application Data
(63) Continuation-in-part of application No. 15/784,721, filed on Oct. 16, 2017.
(60) Provisional application No. 62/408,562, filed on Oct. 14, 2016.

(51) Int. Cl. G06F 17/30

(52) U.S. Cl. CPC G06F 17/30268; G06F 17/30861; G06F 17/30525; G06F 17/3033

(57) ABSTRACT

This disclosure relates to a system for acquiring and sharing annotations of objects that are identified in images found across a computer network. Annotations are stored on a database, thereby allowing multiple users to access to all annotations associated with that object, including annotations made about that object in connection with a completely different image. The database includes pre-defined object data that allows for object identification and for the linking of object annotations between similarly identified objects originating in different media items. The annotation data for the object being viewed may be presented to a new media item in a website browser or other viewing application.

### RELATED APPLICATIONS

This application is a continuation-in-part of U.S. patent application Ser. No. 15/784,721, filed on Oct. 16, 2017, which claimed the benefit of U.S. Provisional Patent Application Ser. No. 62/408,562, filed on Oct. 14, 2016, both of which are hereby incorporated by reference.

### FIELD OF THE INVENTION

This disclosure uses identification techniques that uniquely identify digital images to acquire and share annotations of images over a wide area network. More particularly, separate objects are identified in a plurality of media items over a network, and a database is provided that stores annotations relating to those individual objects. A browser plug-in or alternative application is provided that communicates with a server that maintains the database. Annotations relating to an object image can then be provided to viewers of the object in differing images.

### SUMMARY

The described embodiments use identification techniques on electronic media items to allow the annotations of those media items. The system includes a database where user-created annotations to media items are stored. The database also includes URLs or other address information for the annotated media items, with some items being located at multiple network locations on a wide area network. The database also assigns and stores a fingerprint value for each annotated media item, which can be used to identify the same item when it is accessed at an unknown website or URL.

In the one described embodiment, the database is maintained by a server computer that resides upon the network. The server is further responsible for identifying identical and nearly-identical media items, such as images, that are stored in different locations on the network. The server analyzes images for similarities by using an algorithm or process which is applied to each image in order to create a hash or fingerprint value for each image. This value is then stored in the database. When the same or similar image is accessed from a new URL or website, the same process is applied to this “new” image and a hash or fingerprint value is assigned to it. The server computer is then able to compare the fingerprint value for the new image with the values for images previously analyzed by the server and stored in the database. If the value of the new image meets a threshold similarity value of an existing stored fingerprint value for a matched image, the new image is considered a match by the system. The network location of the new image is then stored in the database as another occurrence of the matched image. Annotations for the matched image that are already stored in the database are then considered applicable for the new image. In this way, annotations applied to one image that is found at various network locations will be stored together and may be applied to new versions of the image as they are accessed and identified by the system.

In certain embodiments, the system for identifying matches between images is based on a hash algorithm, template matching, feature matching, found object identification, facial recognition histogram comparison, or similar value identification and comparison schema such as are known.

Some embodiments include a web browser “plug in” or “extension” which acts to identify images on a web page and communicate with the central server and database that manages and stores annotations and image URL and hash values. In some embodiments, the extension applies a hash algorithm to the image, determines the fingerprint value for that image, and then sends the fingerprint value to the central server for comparison. In other embodiments, the extension will send the web address to the central server, and the central server will be responsible for identifying the image through its URL or by applying the hash algorithm in order to apply the comparison process mentioned above. If a match is made, existing annotations associated with the matched image are made available to the user viewing the new image. If additional annotations are made to the currently viewed image, such annotations are sent to and stored on the central database for sharing with other users viewing that image at the same or different network location.

In one embodiment, object identification algorithms are provided that allow for individual objects to be identified in images or other media items. The object identification can take place at a client device, or at a server. When based on the server, the client will communicate the media address to the server, which will then access the media item and perform object identification. Identified objects will be compared with annotations in the database. If an identified object is associated with existing annotations, these annotations can be shared with the client device. The client device can also receive annotations relating to objects from end users. These annotations are stored in the database and later shared with other viewers of the objects in different images.

### BRIEF DESCRIPTION OF THE DRAWINGS

FIG. 1 is a schematic illustration of an embodiment of a system that can implement the present invention.

FIG. 2 is a flow chart showing a method for implementing an embodiment of the present invention.

FIG. 3 is an alternative embodiment of the system of FIG. 1.

FIG. 4 is another alternative embodiment of the system of FIG. 1 relating to image object annotation.

FIG. 5 is a flow chart showing a method for implementing one embodiment of image object annotation.

### DETAILED DESCRIPTION

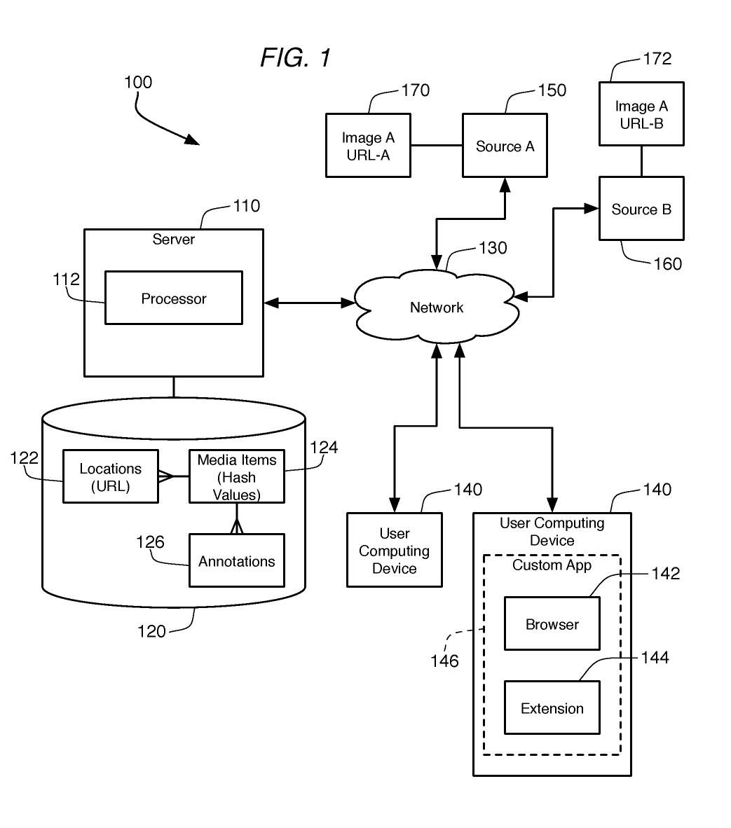

An embodiment of a system 100 for identifying and annotating media content such as digital images is shown in FIG. 1. A core component of such a system 100 is a server 110. This server 110 can be a single computer with a processor 112, or can be a group of computers (each having a processor 112) that cooperate together to perform the task described herein. As is standard with programmed computers, programming instructions stored on memory devices (not shown in FIG. 1) are used to control the operation of the processor 112. The memory devices may include hard disks or solid state memory devices, which provide long term storage for instructions and data, as well as random access memory (RAM), which is generally transitory memory that is used for data and instructions currently be operated upon by the processor 112.

The server 110 is in communication with a database 120. The database 120 may comprise programming and data found on the same physical computer or computers as the server 110. In this case, the database communications between the server 110 and the database 120 will be entirely within the confines of that physical computer. In other embodiments, the database 120 operates on its own computer (or computers) and provides database services to other, physically separate computing systems, such as server 110. When the database 120 operates on its own computer, the database communication between the server 110 and the database 120 may comprise network communications, and may pass over an external network such as network 130 shown in FIG. 1.

In the embodiment shown in FIG. 1, the database 120 includes defined database entities for locations 122, items 124, and annotations 126. In one embodiment, these database entities 122, 124, 126 constitute database tables in a relational database. In other embodiments, these entities 122, 124, 126 constitute database objects or any other type of database entity usable with a computerized database. In the present embodiment, the phrase database record and database entity are used interchangeable to refer to data records in a database whether comprising a row in a database table, an instantiation of a database object, or any other populated database entity. Note that these entities 122, 124, 126 are connected using crow-foot lines to indicate the one-to-many relationships between these entities 122, 124, 126 that are maintained by the database 120.

The server 110 is in electronic communication with a network 130. Network 130 can be any form of computer network such as a local-area network (LAN) or a wide-area network (WAN) such as the Internet.

Communicating over that network 130 and with the server 110 are any of a number and variety of end user computing devices 140. Such devices 140 may be personal computers, smart phones, tablets or other electronic devices capable of and configured for electronic interaction with the network 130 and server 110. Operating on these user computing devices 140 are browser applications or apps 142, which constitute software programming to allow a user to view images, text, and other media content materials that are found on source locations 150, 160 over the network 130. Browser apps 142 are designed to allow the user of the user computing device 140 to select various locations on the network 130, such as source A 150 or source B 160, in order to review the media content found at or presented by those locations 150, 160. More particularly, server computers are present at locations 150, 160 in order to server up media content to remote computers that request such content over the network 130. In some embodiments, the source locations 150, 160 are controlled by web server computers (computers operating web server software) that provide media content in response to URL requests from the remote computers. URLs are Internet based addresses that can uniquely identify content on the Internet. Each item of media content, such as image A 170, will be associated with its own, unique URL. Frequently, identical media content is found at multiple network addresses on the network 130. For instance, Image A 170 is shown on FIG. 1 associated with source 150, but it is also shown as figure number 172 being associated with source 160. As shown in FIG. 1, when stored in connection with Source A 150, Image A 170 has a URL address of URL-A, while the same image 172 at source B 160 has a different URL (URL-B).

To achieve proper interaction with the server 110, user computing devices 140 will include a specially programmed software program such as a web browser “plug-in” or extension, hereinafter referred to generically as extension 144. The extension 144 interacts with the browser 142, and is designed to monitor media content displayed by the browser 142. The extension 144 provides information about this content to the server 110. The extension 144 is also responsible for receiving annotations (stored in annotation database entities 126) about that content from the server 110 and for presenting those annotations to the user through a user interface created by the extension 144. In some instances, this user interface will be integrated into the user interface provided by the browser 142.

It is possible to combine the browser 142 and the extension 144 into a custom application or app 146 that provides the functions of both elements 142, 144. Effectively, such an app 146 would integrate the functionality of the extension 144 into the core programming of the browser 142. Although the use of a custom application 146 has many advantages, the remainder of this description will assume that the extension 144 is separate from the browser 142 and manages all communications with the server 110.

Note that an individual interaction between the server 110 and the extension 144 will typically involve multiple communications back and forth between these elements. These communications can be made through encrypted or otherwise secured communications pathways, as are well-known in the prior art. The communications can use a communications identifier to identify a single communications stream between the extension 144 and the server 110, which can be maintained for all communications about an image.

In general terms, the system 100 of the present disclosure as shown in FIG. 1 identifies media content, such as a digital image A 170, that a user may encounter while browsing network locations. System 100 then aids in determining if that media content has been annotated (by the current user or by any other user) previously. The system 100 achieves this by comparing data associated with this occurrence of the image 170 to that of saved data on the server 110 to determine if that media item (such as image A 170) is identical to, or nearly identical to, image occurrences known to the database 120. If so, the server 110 communicates information stored in the database 120 about that image 170 to the extension 144. In particular, the server 110 can provide annotations (stored in database entities 126) made about that image 170 regardless of where the viewed occurrence is located on the network and regardless of where that image 170 was being viewed when it was previously annotated.

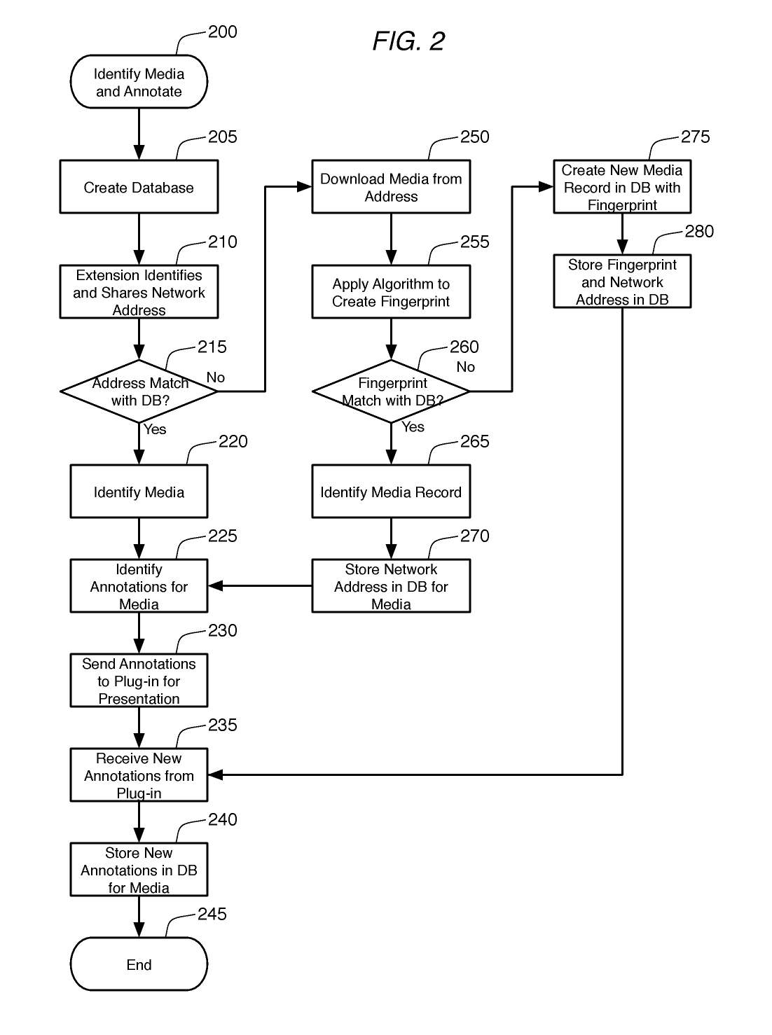

One method 200 for operating this system 100 is shown in FIG. 2. The method 200 begins at step 205, with the creation of the database 120. In this case, the term “create” simply means that the database 120 is programmed and is ready to receive data. The actual data will be input into the database 120 through the rest of the steps of method 200. As explained above, the database 120 is constructed so that a media item database record 124 is created for each image or other item managed by the database 120. Each separately identified image, such as image A 170/172, will preferably have only a single record 124 in the database. This record 124 will contain the fingerprint (or “hash value” or “signature”) for the image that is used to identify identical and extremely similar images on the network 130. A single image or other item identified through record 124 may have multiple copies/instances found on the network 130, each at a separate network location, thereby resulting in multiple location data records 122 for that image record 124. In addition, each image record 124 may have multiple annotations records 126, with each such record 126 containing a separate written (text), audio, or multi-media annotation for the related media item. The annotation records 126 may also contain information about the user that created the annotation (such as the name or type of author of the annotation) and metadata about the annotation (such as when it was created and whether and how the annotation was edited by the author). The item record 124 itself also contain additional metadata about the image or about the image information existing in the database 120. For instance, this metadata may provide a count of the number of locations records 122 identified for the image record 124, or the number of separate annotations 126 that have been collected. The meta data may also include information about the context where the image was originally seen. This content could be provided by the extension 144, and may include a webpage and website that incorporated the image, or the text that was found on a webpage that surrounded the image.

When a user computing device 140 is reviewing material on the network 130, such as the material made available at source A 150, the device 140 will display images and other media content such as Image A170. When the browser downloads and displays this image A 170, the extension 144 notes the image's URL or network location (location URL-A in FIG. 1) and then sends that location to the server 110. This occurs in step 210 in method 200. In one embodiment, the extension 144 analyzes all images that are being displayed by the browser 142 when they are downloaded from the source location 150, 160, and then sends the network location for all images being displayed up to the server 110 for processing. In another embodiment, the extension 144 provides a user interface (such as a pop-up menu item or a button or other GUI interface device) through which a user can request information about the image or images being displayed. In this second embodiment, only when the user explicitly makes this request does the extension 144 determine the image's network address and transmit this address to the server 110. When the browser 142 is viewing a webpage, the extension 144 can identify images in the web page by identifying the source for an <IMG> image tag, as well as related attributes and CSS tags that identify images that will be displayed on a screen (such as background image tags and related CSS definitions). The extension 144 can identify the tags when the web page is first loaded, and can also monitor the browser 142 for additional content, as some content may be dynamically loaded on the webpage based on user interaction with the content.

When the server 110 receives the location data, it compares this data with the location data 122 already stored in the database 120. This comparison takes place at step 215. If the image's location has already been analyzed by the server 110, its network location will be found in location data 122 and a match will be found. In some embodiments, it is not enough that the network location of the viewed image 170 match a network location 122 stored in the database 120 because it is always possible that the same network location will contain different media content items over time. For instance, the network location “www.website.com/images/front-page.gif” may contain the front page image for a website, and may be changed frequently as the website is updated. As a result, in many embodiments step 215 will check not only the network address, but will also check metadata concerning the image. Some relevant metadata for an image may include, for example, the image's resolution and exact data size, or histogram data concerning the image. This information would be stored in the location database record 122 when created, and can either be transmitted by the extension 144 along with the media network location or be separately determined by the server 110. If the network location and the stored metadata all match, step 215 can then be considered to have found a match.

If a match is found at step 215, the image record 124 associated with the matched network location 122 will be accessed to retrieve information about the relevant image at step 220. The server 110 then uses the database 120 to identify the relevant annotations in step 225 by determining which of the annotation records 126 are associated with this image record 124.

The server 110 will return the annotations identified in records 126 and any other relevant information found in record 124 to the extension 144 in step 230. The extension 144 can then present this information and the relevant annotations to the user through the user interface of browser 142. This image information may include image occurrence information (URLs of the occurrences of this image stored in records 122) and all annotation found in records 126 that are associated with this image. In some embodiments, the URLs and annotations are not downloaded en masse to the extension 144, but rather the extension 144 is merely made aware of these elements. Metadata may be provided to the extension 144 to allow a user to see that more information is available about this image. When the user requests specific information, the requested information is then downloaded from the server 110.

In response to any user interaction with a displayed media item in the user interface provided by the extension 144 and browser 142 (clicks, taps, scrolling, hovering, etc.), the extension 144 looks up the relevant information that it received from the server 110. If the extension 144 has additional information to display about the item, it can display that information via overlays, popups, mouse-hover-over or tap-and-hold overlays, side-panels, slide-out panels that slide out from under the image, buttons, notification icons, etc. Interacting with those UI elements can provide the user with any additional information that is available, including annotations provided by the annotation database elements 126. This information can also include a list of other pages that contain similar content based on the location database entities 122. Some annotations will have a text-only representation (stories, comments, etc.), and others may include audio and/or video commentaries concerning the media item. In this context, the phrase “audio-video” commentary includes commentaries that contain visual and audio portions, as well as pure audio and pure video commentaries. It is also possible that the annotations may include links to purchase items relevant to the image, to purchase representations of the image itself, or other suggestions based on the image. Annotations may also include links to other websites which feature the same (or similar) media item.

In addition to displaying existing annotations found in database elements 126, the extension 144 is also capable of received new annotations for the image 170 being viewed. In fact, this “crowd-sourced” ability to gather annotations from a wide-variety of users on the images found on the network 130 is one of the primary advantages of the extension 144. These annotations can take a variety of forms, such as textual, audio, or audio-visual annotations. The annotations can relate to the entire image, or can relate to only a sub-region of the image. For instance, Image A 170 may be an internal image of an ancient Spanish church. A first annotator of the photograph may have created a written annotation for this image, describing the history of this church, and its conversion from a Christian church to an Islamic mosque, and back to a Christian church. A second annotator may have provided an audio commentary on a mosaic that is found in a small portion (or sub-region) of the image. In creating this audio commentary, this person would have specified the sub-region of the image showing the mosaic. The audio commentary would be associated with this sub-region within the annotations database record 126, and an indication of the sub-region may be presented to a later viewer of the image through the extension 144. A third annotator might have created a video annotation showing the interior of the church from the late 1990s. A new viewer of the image can view and examine these annotations through extension 144, even if they are viewing the image on a different website than that which was viewed when the annotations were originally created. This viewer may then elect to comment on a previously created annotation, adding a nuanced correction to the historical description of the church. This new annotation is received by the extension 144 through the browser user interface 142 at step 235, and then reported up to the server 110.

The server 110 will then create a new annotation record 126 in the database 120, and associate this new record with the image record 124 (step 240). This will allow this new annotation to be available for the next viewer of this image, wherever that image may appear on network 130. Since a new annotation may relate to an earlier annotation, the new annotation database record 126 might include a link to the earlier annotation record 126. In some embodiments, the database 120 includes information about users that contribute annotations to the system 100, and each annotation record 126 is linked to a customer record (not shown in FIG. 1). The user record could contain the user's name and age, and publicly displayed user name, their location, their submission history, their rank or status among users, a user type (anonymous, administrator, the website creator for an instance of the image, an image copyright owner, an advertiser, etc.), and their access rights or privileges to the rest of the system 100. In some cases, the user type (such as the copyright owner type) will need to be subject to some type of validation. Business-rules for annotations could be customized based on the user types. For example, copyright owners could specify custom fields describing their images in data record 124, such as licensing info, links to their other work, etc. Advertisers and vendors could add links to places to purchase items in the image, allow people to purchase directly from the image, show other models of the items, etc.

In some embodiments, users that view annotations are encouraged to rank or grade the annotations (such as on a scale from 1-5). The average grade of a user's annotations, and/or the number of annotations created, could be used to assign a grade or level to a user. This information could then be shared each time an annotation of that user is shared. For example, the system 100 could share that a particular annotation was created by the copyright owner of the image (such as the photographer that took the image) or was created by a “5-star” annotator. In some embodiments, an annotator may be requested to self-identify their annotation as a “factual” annotation or an “opinion” annotation (or some other class of annotation). This classification could be stored in the annotation database record 126, and the extension 144 can use these classifications to filter annotations for end user display. End users would then be given the opportunity to object to and correct the author's self-classification to allow crowd-source verification of such classifications.

In other circumstances, it may be useful to link annotation records 126 back to the particular location 122 that was being viewed when the annotation was created. While the primary benefit of the approached described herein is that annotations on a media item 124 apply to any location 122 for that item, tracking the originating location 122 for an annotation 126 may be useful when the annotations are later analyzed and presented. After the annotations are stored in the database 120, the process 200 will then end at step 245.

If step 215 finds that the database 120 does not have a URL record 122 that matches that of network address provided by the extension in step 210, the server 110 then must determine whether this “new” image is in actuality a new image, or merely a new location for a previously identified image. This is accomplished by downloading the image from the provided network address in step 250, and then generating a hash/signature/fingerprint value for the image using an image hashing algorithm in step 255. Image hashing algorithms that are designed to identify identical copies and nearly identical versions of images are known in the prior art. U.S. Pat. Nos. 7,519,200 and 8,782,077 (which are hereby incorporated by reference in their entireties) each describe the use of a hash function to create an image signature of this type to identify duplicate images found on the Internet. An open-source project for the creation of such a hash function is found on pHash.org, which focusses on generating unique hashes for media. Those hashes can be compared using a ‘hamming distance’ to determine how similar the media elements are. The hash works on image files, video files, and audio files, and the same concept could even be applied to text on a page (quotes, stories, etc.).

Once a hash or fingerprint value is generated, it is then compared to other image fingerprint values stored in database 120 within the item information database entities 124 (step 260). The goal of this comparison is to find out whether the newly generated fingerprint value (from step 255) “matches” the hash value found in data entities 124. An exact equality between these two values is not necessary to find a match. For example, a digital GIF, JPEG, or PNG image made at a high-resolution can be re-converted into a similar GIF, JPEG, or PNG image having a different resolution. These two images will create different fingerprint values, but if the correct hash/fingerprint algorithms are used the resulting values will be similar. In other words, they will have a short hamming distance. Similarly, a slightly different crop of the same image may create close, but still different hash values. The test for determining matches at step 255 will reflect this reality and allow slightly different fingerprint values to match and therefore indicate that these slight variations represent the same image.

If a match is found at this step between the hash value of the image identified in step 210 and one of those values stored in the database 122, the server 110 has identified the “new” image as simply a new location for a previously identified image. For example, the server 110 may have previously identified image A at location 172 (URL-B), and then recognized that the image A found at location 170 (URL-A) was identical to this image. If such a match is found and the matching image record is identified (step 265), then the server 110 will create a new location data record 122 in the database 120 and associate this new record 122 with the matching item record 124 (step 270). In one embodiment, this record 122 will include the new URL or network location, the context in which this image or media item was seen (such as the webpage in which the image was integrated and text surrounding the image, which is provided by the extension 144 in step 210), when the image was seen, and metadata related to this image (such as resolution and file size, or histogram values).

In one embodiment, this metadata will also include the hash value generated at step 255, which, as explain above, may be slightly different than the original hash value for the image stored in record 124 even though a match was found in step 260. The storing of hash values in the location records 122 allows the match that takes place at step 260 to include an analysis of the hash values of location records 122 as well as the hash values of the main image records 124. In effect, a new image would then be matched against all instances and variations of the image known by the database 120.

In some embodiments, the hash value comparison at step 260 finds only exact matches in the hash values. These embodiments would misidentify minor modifications to an image as a new image altogether. However, in exchange for this shortcoming, the comparison at step 260 is greatly simplified. There would be no need to determine “hamming” distances, there would be a significantly reduced risk of false matches, and the comparison itself could be accomplished using a simple, binary search tree containing all known hash values in the database 120.

The creation of the new location entity 122 in step 270 means that this instance of the image will be automatically associated with the appropriate image item 124 the next time it is reported by the extension 144 (at step 215), thereby limiting the need to perform the computational intense task of creating the hash value at step 255 and doing the comparison step 260. Once the new location entity 122 is created, the method 200 continues with step 225, with existing annotations and image data for the identified image being transmitted to the extension 144 by the server 110.

In an instance where the server 110 determines that the image 170 is a unique (or, more accurately, is being identified to the server 110/database 120 for the first time because there was no match in step 260), the server 110 will report back to the extension 144 that no match was found. In some cases, the identification of a match in step 260 may not be instantaneous. In these cases, the server 110 may report back to the extension 144 that no match has been found yet. The extension 144 may maintain communication with the server, via a persistent connection such as web sockets (or via polling the server 110, push notifications, or any other means of continuous or repeating communications), to determine if a match is eventually found. If so, processing will continue at step 265. If the server 110 has completed the comparison with all item records 124 (and all location records 122 if they contain hash values), and determined that there is no match, the server 110 will create a new record 124 for the image in database 120 at step 275. This new record 124 will contain the hash/fingerprint value created at step 255 for this image. In addition, the image's URL location will be stored in a new database entity 122 that is associated with this image record 124 (step 280). Since there was not a pre-existing image record 124 in the database for this image, there could not be any existing data or annotations that could be shared with the extension for user consumption. As a result, steps 225 and 230 are skipped, and the method continues at step 235 with the receipt of new annotations from the extension 144.

### Alternative Embodiments

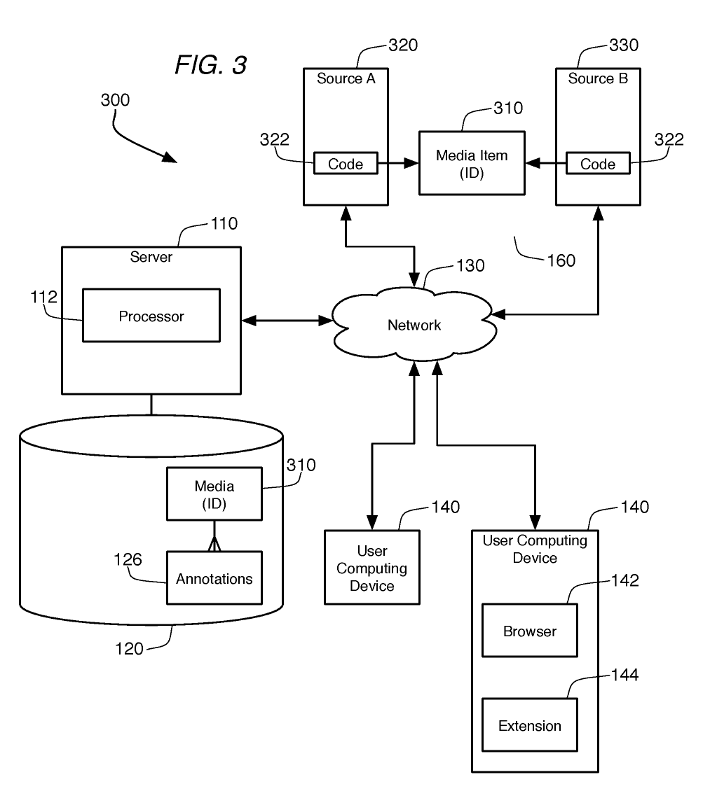

In the alternative embodiment 300 shown in FIG. 3, annotations are created and presented for a media item 310 that can be uniquely identified through an identifier (ID) number so that it is not necessary to use hash algorithms (such as those applied in step 255) to identify multiple occurrences of this item 310. For instance, video stored on a common video server or service (such as the YouTube video service provided by Google Inc. of Mountain View, Calif.) is typically associated with a video identifier. Code 322 can be inserted into web pages 320, 330 that “embeds” the video 310 into the pages 320, 330 by merely identifying the video 310 through its identifier. The same video identifier can be used to embed the same video on hundreds of websites. Similarly, social media content (such as Tweets and Facebook posts) can be embedded based on a similar identifier that uniquely identifies the content.

Using embodiment 300, it is possible to store annotations to the media item 310 at the server 110. The server 110 again has a processor 112 and communicates with a database 120, as was the case in FIG. 1. In this case, however, the item record 310 does not contain a hash value for comparison purposes, but merely contains the identifier of the media item 310. The item record 310 again connects to a plurality of annotation database entities 126. The user computing devices 140 have a browser 142 and an extension 144 that monitors the actions of the browser 142 and communicates with the server 110 in order to provide annotations for the media items 310. When the extension 144 identifies a media item 310 (e.g., a video or social media post) that may be annotated, the identifier for that media item 310 is sent to the server 110, which then determines whether that identifier is found in any current item records 310. If so, annotations 126 for that media item 310 are provided to the user computing device 140. The extension 144 also gives the user the opportunity to create a new annotation to that media item 310. This annotation is communicated through the network 130 to the server 110, and then stored in the database 120 as a new annotation record 126. The method for providing this functionality is much the same as the method 200 described above, with the hash generation and comparison functions being replaced with the steps of transmitting the media item ID to the server for matching with the item record 310. In FIG. 3, no location database entities are shown in database 120. This is because it is not necessary to use network location to help identify media items 310, as the media item identifier provides a unique identification mechanism. It may, nonetheless, prove useful to track all known locations for the embedded media item, and to identify which location is associated with each provided annotation, as was described above.

In another embodiment, a match between an image identified by the extension 144 and the annotated item records 124 is made through a technique other than a hash on the entire image file. The hash algorithms are usually preferred, as they base the comparison on the entire image and are less likely to create false positive matches. However, other techniques currently exist for finding similar photographs, including histogram comparison (comparing the color-lists and relative percentages of two images), template matching (searching for a specific sub-set of one image within another image), feature matching (identifying key-points in an image such as peaks or curves at different locations and comparing those key points with key points of other images), contour matching (identifying image contours and comparing those contours to other known contours), object matching (machine-learning that identifies objects in images and comparing the found-object-locations of those images with found-object-locations of those objects in other images), and facial-recognition (using facial recognition and the locations of key facial features within the images to find similar images). Each of these techniques could be used in place of the hash algorithms described in connection with FIGS. 1 and 2. While at the current time these alternatives would appear to provide less precession than the hash values, this can change as these alternatives are improving over time with additional research and effort.

It is possible to implement the above embodiments without using an extension 144 or a custom application 146. To accomplish this, a server-side embeddable widget must be placed on a web page that incorporates and calls programming from a main provider site, much in the say way in which Google's Google Analytics service operates. Any page that includes this widget would be automatically enabled for enhanced-viewing of the annotations 126, 420. By incorporating the functionality on the server-side, this could increase the ability of the present invention to work on mobile devices, as mobile device browsers are less likely to work with extensions.

It is also possible to skip the location based comparison at step 215 in FIG. 2. Instead, viewed media content items would be compared to items in the database 120 using only the fingerprint/hash comparison of step 260. In this case, the hash value could even be created by the extension 144 on the user computing device 140 and then submitted directly to the server 110, which would reduce the workload of the server processor 112.

Finally, it is possible to develop an external interface to the database 120 that would allow direct access to and searching of the database 120. This interface would allow users to input search criteria relating to items, people, places, photos. This search criteria could then be compared with the items 124, objects 410, and annotations 126, 420 within database 120. The database 120 will then return any matching content found within the database (such as annotations 126, 420), as well as links to the locations 122 that contain the related content. This would allow, for instance, users to search for photographs of a particular individual. The annotations and metadata would be searched for that individual, and the URLs associated with matching annotations could be identified and shared with the searching user. Complex searches of images and other media types would become possible that would otherwise be impossible, all while using crowd-sourcing techniques creating the annotations that are used to search the media content.

### Object Identification and Influencer Annotations

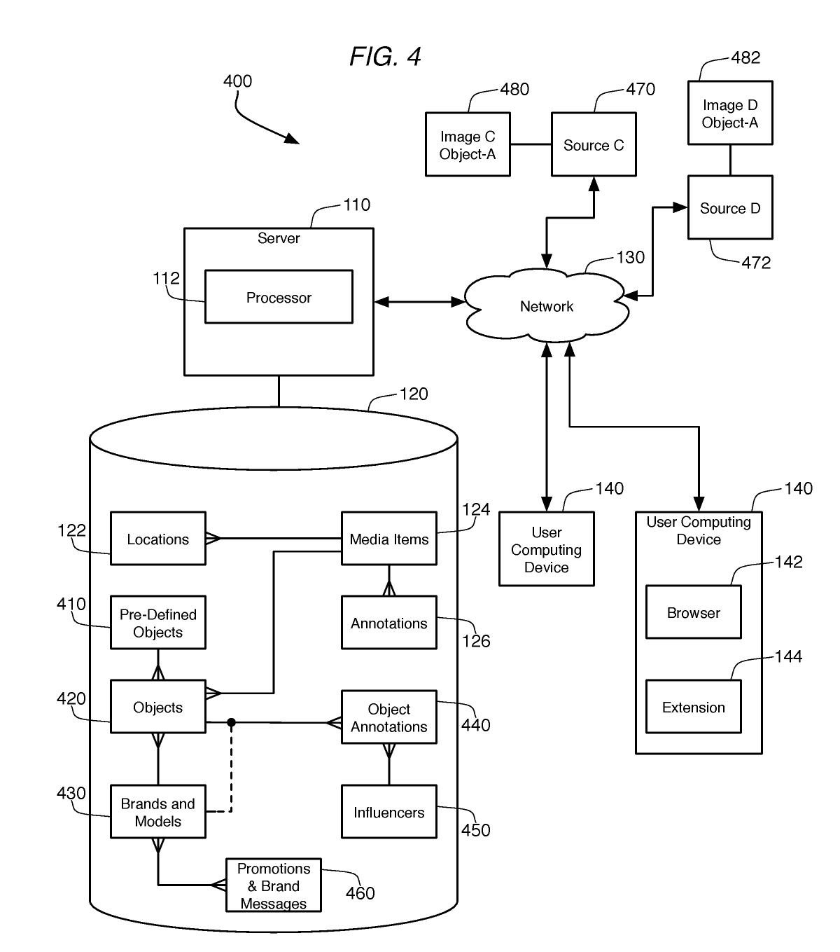

FIG. 4 shows another embodiment in which separate objects are identified within individual images and media items, and annotations are then provided directly on one of the identified objects. This system 400 requires the ability to recognize separate objects within the media items 124. This ability is performed using known object recognition algorithms that use any of a variety of techniques for pattern recognition and machine learning. Examples of object identification technology known in the prior art include the identification performed by Pinterest (San Francisco, Calif.) as described in their March 2017 white paper (available on the arXiv.org website at arXiv:1505.07647v3). Google (Mountain View, Calif.) also conducts object identification in their image search, and has described some of their techniques in a variety of published US patents and patent applications (see, e.g., U.S. Pat. Nos. 9,678,989 and 8,837,819). In fact, in June of 2017, Google opened its TensorFlow Object Detection system for open source use to simplify the construction of object detection systems that can reliably identify multiple objects within a single image.

Object identification processes can be divided into appearance-based processes that use templates or example images for comparison to identify an object, and feature-based processes that define individual features of the object such as corners, edges, and surfaces. Both types of processes require that information about the objects be learned or input before those objects can be identified in real-world images. In FIG. 4, pre-defined objects 410 are shown forming part of database 120 for the purpose of showing that this information is accessible to the rest of the system 400. It is not necessary that this information 410 be fully stored in the same database 120 that contains information about media items 124 and annotations 126, but this is one possible configuration. The pre-defined objects database entities 410 contain the characteristics or examples for numerous objects that are used to identify objects during analysis by the system 400. In most cases, it makes sense for the pre-identified objects 410 to be organized into a structured set of objects. For instance, some of the pre-identified objects 410 might be grouped together under a category that defines a subset of all objects. One such category would be furniture. Other objects 410 would be placed into sub-categories of this furniture category, such as tables and chairs. Tables could also be sub-categorized into dining tables, card tables, and folding tables. Dining tables could be further divided by styles of tables, such as Queen Anne, Georgian, Chippendale, Victorian, Mission, and Shaker. Even particular styles of dining tables might be further divided into sizes, manufacturers, and models. The process of pre-defining the objects 410 makes it possible to identify items in media objects found over the network 130, such as image C 480 and image D 482, as shown in FIG. 4. Each pre-defined object entity 410 contains sufficient information to make identification of that object possible by the object identification process.

Once the pre-defined objects 410 and their associated definitions and hierarchy have been created, object identification algorithms can identify objects found in the images and other media items. In database 120, objects identified through these techniques are recorded as database elements 420. These elements 420 contain information about the found objects and include links to other database entities within database 120. For instance, the object entities 420 are linked to the media items 124 in which the object was found. This connection allows the database 120 to identify the source URL location (found in location entity 122) where this particular object 420 can be found. In addition, the object entity 420 is associated with one of the pre-defined object entities 410, which allows an easy determination of the identification of that object 420. Because of the hierarchical structure of the pre-defined objects 410, an association with one of the pre-defined objects 410 includes an automatic association with all other objects above the associated object in the hierarchy. For example, a link to a Mission table pre-defined object 410 indicates that the identified object is an object of furniture, a table and a dining table. Sometimes the algorithm that identifies an object 420 cannot make a determination at the lowest level of the hierarchy of pre-defined objects 410. The algorithm may know that the object being identified is definitely a dining table, for instance, but cannot determine whether it is a Mission or a Shaker table. By associating the identified object 420 with the appropriate pre-defined object database entity 410, the lack of clarity is handled in an efficient manner.

The process for identifying these object entities 420 may be quite time intensive, and are probably best performed by the server 110 after a media item is first identified and placed into a new item database entity 124. In some embodiments, the server 110 itself will perform the object identification algorithms on its own processor 112, but it is equally likely that an external service provided over the network 130 will be able to identify objects in a particular media item/image more efficiently. For instance, Clarifai, Inc. (New York, N.Y.) provides an API allowing developers on the Internet to use their Clarifai service to perform object identification on images within a developer's own applications.

It is also useful to identify brand names and logos within the images 124. Technology similar to object recognition can be used to identify visual logos and written brand names within the media items 124. Again, these brand identification techniques can be performed on the server 110, or can be outsources to an external service provider. One such service provider is LogoGrab, Ltd. (Dublin, Ireland), which provides an API for developers to use that is able to identify over 10,000 logos and brand names from images. Once identified, this identification can be stored within the database 120. In FIG. 4, database entities 430 contain information about brands and the products and services that are provided under those brand names. Like the pre-defined objects 410, the brands and products database entities 430 can be pre-defined. For example, the brand Nike might be identified through its swoosh logo or its name, and this brand may be associated in the database 120 with all of the products that Nike has manufactured. An object 420 that is identified in a media item as a running shoe will be linked to a running shoe object 410 within the database 120. The logo on the shoe could also be identified, linking the object 420 to the Nike brand database entity 430. The links between objects 420 and brands 430 can be based on a variety of techniques, such as a determination that the logo is identified within a media item 124 at the same location (and same time in the case of a video media item) as the object 420. Information about the products or models produced by Nike could be accessed through the related model database entities 430, and additional identification techniques can be used to associate the identified object 420 with a particular model of running shoe 430 made by Nike. If it is not possible to link to a particular model of shoe created by Nike, the object 420 would remain linked to the running shoe pre-defined object 410 and the Nike brand 430.

Although FIG. 4 shows the brands and models database entities 430 as separate from the predefined objects 410, these elements could easily be combined. The identification of a particular brand or model of an object (for instance, Nike Air Jordan basketball shoes) is really nothing more than an identification of a particular type of object 410. Hence, the brands and objects could be theoretically integrated into the pre-defined object hierarchy 410. Of course, one brand (Nike) can apply to thousands of different objects, which is why brands and models 430 was separated as a distinct identifier for an object 420 in FIG. 4.

Once the object 420 is identified and entered into the database 120, object annotations 440 can be associated with the objects 420. Object annotations 440 are similar to media item annotations 126, but are related to a particular object 420 within a media item 124 and not the entire media item 124. For instance, in the example above, annotations were created concerning an ancient Spanish church. These annotations 126 related to a particular image 124 of that church, and could be shared whenever a viewer saw that image 124 over the network, even if the image were slightly altered (different resolution or cropping) and located at a different network address when compared to its appearance and location when originally annotated. But a different photograph of that same church would not be associated with those annotations 126. In contrast, object annotations 440 relate to objects within the media items 124, not the media items themselves. Thus, if the pre-defined object entities 410 included famous landmarks and buildings, object annotations 440 could be directly associated with the objects 420 associated with that church. When other images of that same church are analyzed, an object entity 420 would be created and associated with the pre-defined object 410 for that church. As a result, object annotations 440 associated with that pre-defined object 410 would automatically be associated with the church in the new image and could be presented to a user viewing that image. This means that a user viewing a photograph of that church found on any website would be able to view relevant annotations even though the photograph and website were previously unknown to the system 400.

The above example shows that the linking of object annotations 440 to objects 420 and pre-defined objects 410 includes some subtleties. The object database entity 420 relates to a particular object found in a particular media item 124. It is associated with a predefined object 410, which serves as an identification for that object 420. Following the crows-foot notation of FIG. 4, an object annotation 440 can be tied to a single object entity 420, which in turn is related to a single media item 124. The media items 124 can be linked to multiple locations 122. If these were the only links/associations within database 120, object annotations 440 would not function significantly differently than media item annotations 126. The annotations 440 would relate to a single object 420, but only in connection with a media item 124—one particular photograph of the church in the example above. While that photograph might be found in multiple locations 122 on the network 130, a different photograph of the same church would not necessarily find the related object annotations 440. To obtain the proper result, the object database entity 420 is also linked to a pre-defined object 410. Given the relationships of FIG. 4, once an object 420 is associated with a pre-defined object 410, it is a trivial matter to find all object annotations 440 related to any of the other objects 420 that are associated with the same pre-defined object 410.

A similar subtlety exists in connection with the associations between objects 420 and brands and brand models 430. An object 420 relating to a pair of athletic shows can be associated with a single pre-defined brand/model database entity 430 created for Nike's Air Jordan XXXI shoe. Object annotations 440 can be entered into the database 120 relating to a particular object 420 in a particular media item 124, but since that object 420 is associated with the Air Jordan XXXI model entity 430, that annotation 440 can be accessed any time another photograph containing that shoe is found and identified.

The database 120 shown in FIG. 4 shows that object annotations 440 can be associated with influencers 450. Influencers 450 are database entities associated with real-life individuals that have the ability to influence a wider audience. These individuals may be celebrities, sports figures, fashion experts, or even “social media stars” that have numerous on-line followers. For some users, an annotation on an item of clothing from a celebrity or social media star may be of more interest than comments made by other users. Because of this, object annotations 440 associated with an influencer 450 can be sorted to the top of a list of annotations concerning an object. Alternatively, the browser plug-in or app may present normal object annotations 440 passively (only if a user requests to see the annotations) while presenting influencer annotations actively (immediately presenting either the annotation or some indicator/icon that indicates that an influencer annotation is available for this object). In some cases, an influencer might be compensated for making comments on a particular product. In these cases, the object annotation 440 may not relate to a particular media item 124 at all (which is affiliated with a single image/media item 124), but instead will relate to a particular product uniquely identified in a brand/model database entity 430. In this case, the object annotation 440 may directly link to this database entity 430, as shown by the dotted line in FIG. 4. Note that, in this context, “direct” links can refer to a direct association in the database 120 between database entities, while “indirect” links refers to associations that pass through one or more intermediate entities.

Similarly, manufacturers and retailers might wish to provide annotations about their products as well. These are contained in the promotions/brand messages database entities 460. These messages may not be any different than object annotations 440, except they are associated directly with brands/models 430 instead of a particular object 420 identified in a media item 124. They might also take the form of promotions, discounts, or offers to sell a particular product. If, using cookies, a retailer already had acquired payment and delivery information from a user, a promotion 460 may include a “one-click” offer to sell and ship the product being viewed.

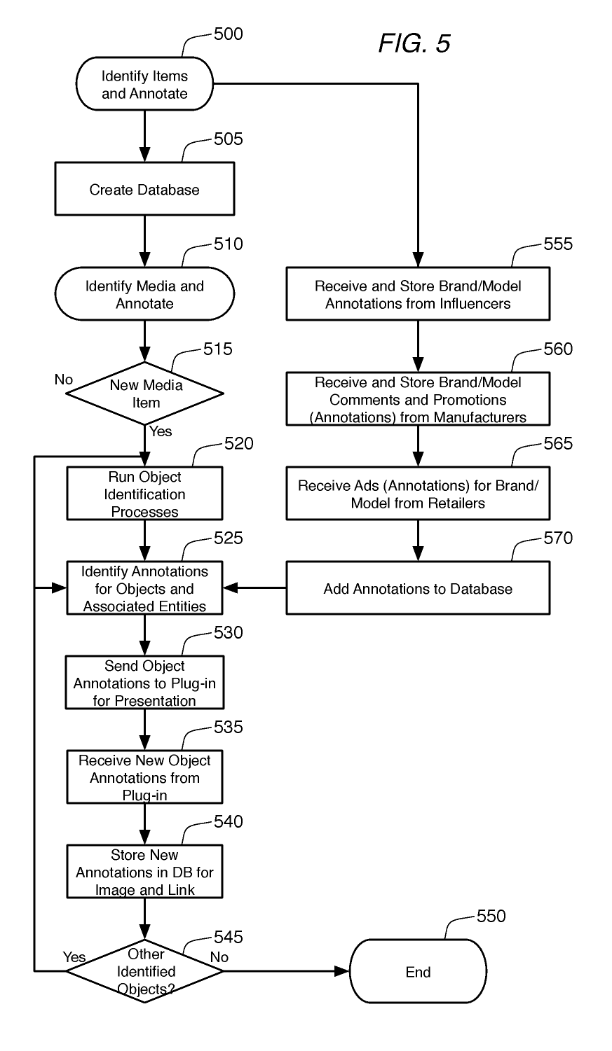

FIG. 5 shows a method 500 to identify items and media items and create and present item annotations. The method 500 begins with the creation of the database 120. This 505 step is similar to step 205 described above, although it includes the creation of the pre-defined object entities 410 and the brands and models entities 430. These items 410, 430 can also be added once the method 500 is underway, but the method 500 will not work properly if the pre-defined objects 410 entities do not pre-exist. Remember, of course, that third-party service providers such as Clarifai are able to identify objects in images and media items using their own pre-defined objects, so it may not be necessary for the implementer of method 500 to create their own such entities 410. The next step 510 in method 500 is to identify the media items 124 in an image and to receive and present media annotations 126. This step 510 can be implemented using method 200. It is not necessary to present media annotations 126 as part of method 500, but at least one embodiment allows for the coexistence of media annotations 126 and object annotations 440.

Step 515 of the method 500 determines whether a new media item 124 is being viewed by the browser/media viewer of the user. If the media item 124 is new, this means that the system 400 has not yet performed object identification on this media. As a result, the object identification process is performed at step 520. As explained above, object identification requires an examination of the image/media item to determine whether any identifiable objects are contained within the media. The process can use one of a variety of object identification methods, and can even utilize third party services. In the preferred embodiment, the process identifies objects in the media item and records each identified object as a separate object database entity 420. These entities 420 are associated with the pre-defined object 410 that was identified in this step, as well as any particular brand/model 430 that was also identified. If step 515 indicates that the media item has already been analyzed (it is old), step 520 can be skipped. In some circumstances, new pre-defined objects 410 and brands/models 430 can be added to the database 120 since the last time the known media item 124 was analyzed. In these cases, it may make sense to perform step 520 again on the media item 124 to determine if new objects 420 can be identified, or if the identification of objects 420 can be improved with the new information.

At step 525, the method 500 finds object annotations 440 related to the objects 420 identified in the media item 124. Some of these annotations 440 may be identified with influencers 450. In addition, some of these annotations may take the form of promotions and brand messages 460 from manufacturers and retailers. All of these annotations 440, 460 are then sent to the user's device for possible presentation to the user in step 530. The presentation can be similar to that described above for media annotations 126 in method 200. Furthermore, the user's browser/plug-in/app may distinguish between different annotations 440/460 so that influencer annotations 440 and paid messages 460 receive greater prominence or are presented actively. At step 535, individual users are allowed to provide their own object annotations using their browser/plug-in/app. These new annotations are received from the user's device and then stored in the database as elements 440 at step 540.

Step 545 represents the fact that a particular media item 124 may contain multiple objects 420. As a result, annotations must be identified and downloaded to the user device for each object, and new user annotations can be received and stored for each object. Thus, step 545 indicates that, if some objects have not been processed, the method returns to step 525. In actuality, steps 525-540 are not handed sequentially for each object but instead are likely handled in parallel. All annotations 440 for all objects 420 can be identified and downloaded (steps 525 and 530) together. Furthermore, new object annotations will not be handled separately for each object 420 but will be handled for any object 420 when an annotation 440 is received from the user. The process ends at step 550.

Steps 555-570 relate to the development of object-related annotations 440 and messages 460 outside the display of individual media items 124. At step 555, the system 400 receives object annotations 440 from influencers 450. These may include comments made by celebrities or social media stars on a particular brand/model product such as an article of clothing, a clothing accessory, or a new car model. These annotations are stored as entities 440 and are identified with the influencer 450 so that they can be handled differently by the system 400. Similarly, at step 560, messages from a manufacture about their product can be received and stored as database elements 460. At step 565, promotions (and perhaps purchase opportunities) 460 are received from retailers and stored in the database 120. These annotations 440/messages 460 are then made available for presentation to users starting at step 525.

The many features and advantages of the invention are apparent from the above description. Numerous modifications and variations will readily occur to those skilled in the art. Since such modifications are possible, the invention is not to be limited to the exact construction and operation illustrated and described. Other aspects of the disclosed invention are further described and expounded upon in the following pages.

I claim:

1. A method comprising:
a) constructing a database having:
i) media item records each identifying a media item accessible on a network,
ii) pre-defined object records each identifying a pre-defined object,
iii) object records associated with the media item records and with the pre-defined object records, each object record identifying an object displayed in the media item identified in the associated item record, and each object record identifying the object as the pre-defined object identified in the associated pre-defined object record; and
iv) object annotation records associated with the object records, each object annotation record containing an object annotation concerning the object identified in the associated object record;
b) at a server computer, creating a first media item record identifying a first media item found on the network;
c) at the server computer, identifying a first object in the first media item as a first pre-defined object identified in a first pre-defined object record and creating a first object record associated with the first media item record and associated with the first pre-defined object record;
d) at the server computer, receiving from a first client computing device a first annotation relating to the first object;
e) at the server computer, creating a first annotation record identifying the first annotation, the first annotation record being associated with the first object record;
f) at the server computer, receiving from a second client computing device an identification of a second media item found on the network;
g) at the server computer, identifying a second object the second media item as the first pre-defined object; and
h) at the server computer, transmitting the first annotation to the second client computing device to be displayed by the second client computing device in association with the second media item.

2. The method of claim 1, further comprising a second annotation record associated with the first pre-defined object record, wherein the server computer transmits a second annotation identified by the second annotation record to the second client computer device along with the first annotation.

3. The method of claim 2, wherein the second annotation record is associated directly with the first pre-defined object record.

4. The method of claim 2, further comprising an influencer record associated with the second annotation record, the influencer record identifying an influencer author of the second annotation.

5. The method of claim 4, wherein the second client computing device displays the second annotation more prominently than the first annotation because the second annotation is authored by an influencer.

6. The method of claim 2, wherein the database further comprises brand records associated with the object records, each brand record identifying a particular brand for the objects identified in the associated object records.

7. The method of claim 6, wherein the second annotation record is associated with a first brand record indicating that the second annotation relates to a first brand identified in the first brand record.

8. The method of claim 7, wherein the second annotation record is directly associated with the first pre-defined object record, indicating that the second annotation relates to the first brand and the first pre-defined object.

9. The method of claim 2, wherein the second annotation record is associated with a second pre-defined object, wherein the first pre-defined object and the second pre-defined object form a hierarchy of pre-defined objects.

10. The method of claim 9, wherein the second annotation record is directly associated with the second pre-defined object.

11. The method of claim 9, wherein the first pre-defined object identifies a subset of the second pre-defined object.

12. The method of claim 2, wherein the first annotation is textual, and the second annotation comprises audio-video commentary.

13. The method of claim 2, wherein the first media item is an image.

14. A server apparatus comprising:
a) database communications to a database, the database having:
i) media item records each identifying a media item accessible on a network,
ii) pre-defined object records each identifying a pre-defined object,
iii) object records associated with the media item records and with the pre-defined object records, each object record identifying an object displayed in the media item identified in the associated item record, and each object record identifying the object as the pre-defined object identified in the associated pre-defined object record; and
iv) object annotation records associated with the object records, each object annotation record containing an object annotation concerning the object identified in the associated object record;
b) a computer processor operating under programmed control of programming instructions;
c) a memory device containing the programming instructions; and
d) the programming instructions on the memory device, operably by the processor to perform the following functions:
i) create a first media item record identifying a first media item found on the network,
ii) identify a first object in the first media item as a first pre-defined object identified in a first pre-defined object record and creating a first object record associated with the first media item record and associated with the first pre-defined object record,
iii) receive from a first client computing device a first annotation relating to the first object,
iv) create a first annotation record identifying the first annotation, the first annotation record being associated with the first object record,
v) receive from a second client computing device an identification of a second media item found on the network,
vi) identify a second object the second media item as the first pre-defined object, and
vii) transmit the first annotation to the second client computing device to be displayed by the second client computing device in association with the second media item.
